(19) United States
(12) Patent Application Publication
(10) Pub. No.: US 2023/0415695 A1
(43) Pub. Date: Dec. 28, 2023

(54) SAFETY RESTRAINT SYSTEM FOR LOWER EXTREMITIES IN AUTOMATED DRIVING

(71) Applicant: HONDA MOTOR CO., LTD., Tokyo (JP)

(72) Inventors: Christoph KERKELING, OFFENBACH/AM MAIN (DE); Jessica KIRCH, OFFENBACH/AM MAIN (DE); Jan THIELMANN, OFFENBACH/AM MAIN (DE); Jens NESSLER, OFFENBACH/AM MAIN (DE)

(73) Assignee: HONDA MOTOR CO., LTD., Tokyo (JP)

(21) Appl. No.: 17/848,403

(22) Filed: Jun. 24, 2022

(51) Int. Cl. B60R 22/02; B60R 22/26; B60R 21/015

(52) U.S. Cl. CPC B60R 22/02; B60R 22/26; B60R 21/01552; B60R 2022/027; B60R 2022/1818

(57) ABSTRACT

An occupant protection device includes a pair of first and second lap belt guiding surfaces, a pair of first and second shoulder belt guiding surfaces, a pair of first and second thigh belt guiding surfaces and a connector. A pair of left and right lap belts, are withdrawable from the pair of first and second lap belt guiding surfaces to restrain a waist of a seated occupant. A pair of left and right shoulder belts are withdrawable from the pair of first and second shoulder belt guiding surfaces to restrain an upper body of the seated occupant. A pair of left and right thigh belts are withdrawable from the pair of first and second thigh belt guiding surfaces to restrain thighs of the seated occupant, wherein the pair of lap belts, the pair of shoulder belts and the pair of thigh belts are connected to the connector.

### BACKGROUND

### Technical Field

The disclosure relates to a safety restraint system and more specifically relates to a safety restraint system for lower extremities.

### Description of Related Art

In Patent Literature 1, an airbag is disposed between vehicles seats that are placed facing each other. In an event of a vehicle collision, the airbag expands in a vehicle upward direction to restrain the occupant.
Patent literature 1: Japanese Patent Laid-Open No. 2020-029218

However, in the event of the vehicle collision, the lower limbs (such as the thigh and/or the feet) of the occupant may float in the air. Accordingly, a solution is needed to restrain a movement of the lower limbs of the occupant in the event of the vehicle collision.

### SUMMARY

According to an embodiment of the disclosure, an occupant protection device is adapted for a vehicle. The occupant protection device includes a first pre-tensioner, a second pre-tensioner, a third pre-tensioner and a connector. A pair of left and right lap belts are configured to be withdrawable from the first pre-tensioner to restrain a waist of a seated occupant. A pair of first and second lap belt guiding surfaces are disposed towards a rear side of a seat cushion in a front-rear direction of the seat cushion, the first lap belt guiding surface is disposed at a first side surface of the seat cushion and the second lap belt guiding surface is disposed at a second side surface of the seat cushion. A pair of left and right shoulder belts are configured to be withdrawable from the second pre-tensioner to restrain an upper body of the seated occupant. A pair of first and second shoulder belt guiding surfaces are disposed at a side of a seat back that is away from the seat cushion. A pair of left and right thigh belts are configured to be withdrawable from the third pre-tensioner to restrain thighs of the seated occupant. A pair of first and second thigh belt guiding surfaces are disposed towards a front side of the seat cushion in the front-rear direction of the seat cushion, the first thigh belt guiding surface is disposed at a third side surface of the seat cushion and the second thigh belt guiding surface is disposed at a fourth side surface of the seat cushion, wherein the lap belts, the shoulder belts and the thigh belts are connected to the connector.

### BRIEF DESCRIPTION OF THE DRAWINGS

FIG. 1 is a schematic diagram illustrating a perspective view of an occupant protection device according to an embodiment of the disclosure.

FIG. 2 is a schematic diagram illustrating a retractor mechanism according to an embodiment of the disclosure.

FIG. 3A is a schematic diagram illustrating an undeployed state of an airbag system for lower extremities according to an embodiment of the disclosure.

FIG. 3B is a schematic diagram illustrating a deployed state of the airbag system for lower extremities according to an embodiment of the disclosure.

FIG. 4A is a schematic diagram illustrating an undeployed state of an airbag system having a guide rail according to an embodiment of the disclosure.

FIG. 4B is a schematic diagram illustrating a deployed state of the airbag system having a guide rail according to an embodiment of the disclosure.

FIG. 5 is a schematic flow diagram illustrating a deployment of a safety restraint system for lower extremities according to an embodiment of the disclosure.

### DESCRIPTION OF THE EMBODIMENTS

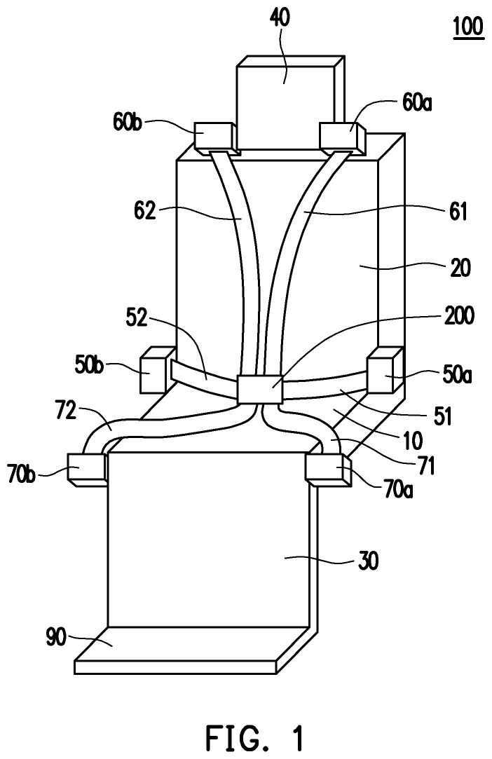

FIG. 1 is a schematic diagram illustrating a perspective view of an occupant protection device according to an embodiment of the disclosure. Referring to FIG. 1, an occupant protection device 100 adapted for a vehicle is provided. The vehicle is, for example, a car having an automated driving function. The occupant protection device 100 includes a seat cushion 10, a seat back 20, an ottoman 30, a head rest 40 and a foot rest 90.

The seat cushion 10 and the seat back 20 may form an L-shaped structure. In more detail, the seat back 20 extends from a rear side of the seat cushion 10 in a front-rear direction of the seat cushion 10, and the seat back 20 extends away from the seat cushion 10. The head rest extends from a side of the seat back 20 that is away from the seat cushion 10, and the head rest 40 extends away from the seat back 20.

The ottoman 30 extends from a front side of the seat cushion 10 in the front-rear direction of the seat cushion 10, and the ottoman extends away from the seat cushion 10. The foot rest 90 extends from a side of the ottoman 30 that is away from the seat cushion 10, and the foot rest 90 extends away from the ottoman 30. The foot rest 90 is provided at the ottoman 30 and configured to function as a feet rest of a seated occupant.

An extension direction of the seat back 20 may be, for example, substantially parallel with an extension direction of the ottoman 30. In addition, an extension direction of the head rest 40 may be, for example substantially parallel with the extension direction of the seat back 20. Furthermore, an extension direction of the seat cushion 10 may be, for example, substantially parallel with an extension direction of the foot rest 90. However, the seat back 20 and the ottoman 30 may be reclinable. That is to say, the seat back 20 and the foot rest 90 are adjustable. The ottoman 30 is provided at the seat cushion 10 and configured to support legs of the seated occupant.

The occupant protection device 100 is provided with a 6-point belt system. The occupant protection device 100 includes a pair of first and second lap belt guiding surfaces 50a, disposed towards a rear side of the seat cushion 10 in the front-rear direction of the seat cushion 10, the first lap belt guiding surface 50a is disposed at a first side surface of the seat cushion 10 and the second lap belt guiding surface 50b is disposed at a second side surface of the seat cushion 10. The first side surface of the seat cushion 10 is a surface opposite to the second side surface of the seat cushion 10.

The pair of first and second lap belt guiding surfaces 50a, 50b are belt guides having guiding surfaces configured to guide a pair of left and right lap belts 51, 52, by contacting the pair of left and right lap belts 51, 52 respectively. In other words, the first lap belt guiding surface 50a is configured to guide the left lap belt 51, while the second lap belt guiding surface 50b is configured to guide the right lap belt 52. The pair of left and right lap belts 51, 52 are configured to restrain a waist of a seated occupant.

The occupant protection device 100 further includes a pair of first and second shoulder belt guiding surfaces 60a, 60b disposed at a side of the seat back 20 that is away from the seat cushion 10. The pair of first and second shoulder belt guiding surfaces 60a, 60b are belt guides having guiding surfaces configured to guide a pair of left and right shoulder belts 61, 62, by contacting the pair of left and right shoulder belts 61, 62 respectively. In other words, the first shoulder belt guiding surface 60a is configured to guide the left shoulder belt 61, while the second shoulder belt guiding surface 60b is configured to guide the right shoulder belt 62. The pair of left and right shoulder belts 61, 62 are configured to restrain an upper body of the seated occupant.

In addition, the occupant protection device 100 includes a pair of first and second thigh belt guiding surfaces 70a, 70b disposed towards the front side of the seat cushion 10 in the front-rear direction of the seat cushion 10, the first thigh belt guiding surface 70a is disposed at a third side surface of the seat cushion 10 and the second thigh belt guiding surface 70b is disposed at a fourth side surface of the seat cushion 10. The third side surface of the seat cushion 10 may be the same side surface as the first side surface of the seat cushion 10, at which the first lap belt guiding surface 50a is disposed, or a different side surface from the first side surface. In addition, the fourth side surface of the seat cushion 10 may be the same side surface as the second side surface of the seat cushion 10 at which the second lap belt guiding surface 50b is disposed, or a different side surface from the second side surface.

The pair of first and second thigh belt guiding surfaces 70a, 70b are belt guides having guiding surfaces configured to guide a pair of left and right thigh belts 71, 72, by contacting the pair of left and right thigh belts 71, 72 respectively. In other words, the first thigh belt guiding surface 70a is configured to guide the left thigh belt 71, while the second thigh belt guiding surface 70b is configured to guide the right thigh belt 72. The pair of left and right thigh belts 71, 72 are configured to restrain thighs of the seated occupant.

In the present embodiment, the first and second lap belt guiding surfaces 50a, 50b, the first and second shoulder belt guiding surfaces 60a, 60b and the pair of first and second thigh belt guiding surfaces 70a, 70b are belt guides having belt guiding surfaces for guiding the 6-point belt system. In another embodiment of the disclosure, the first and second lap belt guiding surfaces 50a, 50b, the first and second shoulder belt guiding surfaces 60a, 60b and the pair of first and second thigh belt guiding surfaces 70a, 70b may be rotating rollers having guiding surfaces guiding the belts.

The occupant protection device 100 further includes a connector 200, wherein the pair of left and right lap belts 51, 52, the pair of left and right shoulder belts 61, 62 and the pair of left and right thigh belts 71, 72 are connected to the connector 200. More specifically, the connector 200 may be, for example, a buckle. The pair of left and right lap belts 51, 52, the pair of left and right shoulder belts 61, 62 and the pair of left and right thigh belts 71, 72 may each have a latch connected thereto. The latch may be, for example, a buckle tongue, wherein the buckle tongue of each belt is latched to the buckle (connector 200) to secure the 6-point belt system. The connector 200 may be permanently connected to at least one of the 6 belts to prevent the connector 200 from becoming lost.

The pair of left and right thigh belts 71, 72 run from the seat cushion 10 outer front corners across left and right thigh of the seated occupant to the belt buckle 200 located at a center of the pelvis of the seated occupant. The pair of left and right thigh belts 71, 72 may prevent lifting of occupant thighs from the seat cushion 10 during a vehicle collision. In this way, the 6-point belt system restrains the occupant to the seat cushion 10 in the event of the vehicle collision. In addition, the lower limbs of the occupant may be restrained by the pair of left and right thigh belts 71, 72.

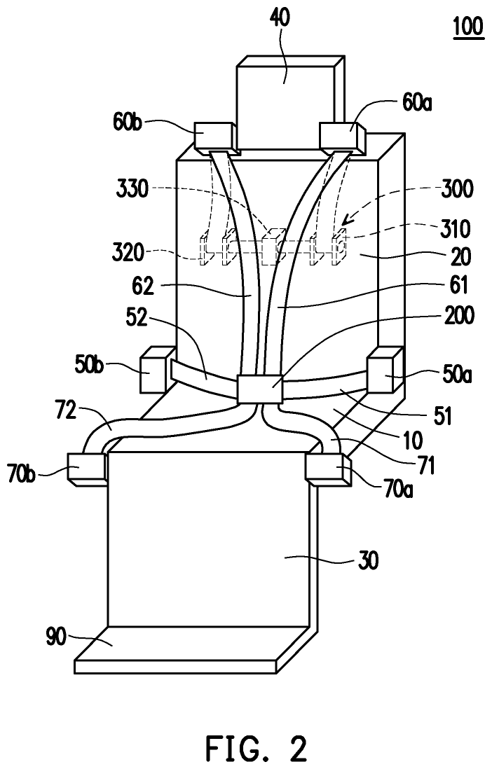

FIG. 2 is a schematic diagram illustrating a retractor mechanism according to an embodiment of the disclosure. Referring to FIG. 2 a retractor mechanism 300 is disposed inside the seat back 20. In the present embodiment, the retractor mechanism 300 has a pretensioning function and a retracting function. In more detail, the pretensioning function of the retractor mechanism 300 may be implemented by a pretensioner, for example, by electrical, pyrotechnical or other means. The pretensioner may quickly remove slack from the pair of left and right shoulder belts 61, 62 in an event of a vehicle collision. The retracting function of the retractor mechanism 300 may be implemented by a pair of first and second spools 310, 320 and a retracting device 330. The left shoulder belt 61 is wound in the first spool 310, while the right shoulder belt 62 is wound in the second spool 320. The retracting device 330 is connected to both the first spool 310 and the second spool 320 to control the extraction and retraction for the first spool 310 and the second spool 320 simultaneously using the single retracting device 330. The retracting device 300 includes, for example, a spiraled spring that rotates the first spool 310 and the second spool 320 to keep the pair of left and right shoulder belts 61, 62 taut.

An example configuration of the retractor mechanism 300 including the pretensioning function and the retracting function have been described above. In the present embodiment, the occupant protection device 100 having a 6-point belt system includes a first retractor mechanism, a second retractor mechanism and a third retractor mechanism. The pair of left and right lap belts are configured to be withdrawable from the first retractor mechanism to restrain a waist of a seated occupant. The pair of left and right shoulder belts are configured to be withdrawable from the second retractor mechanism to restrain an upper body of the seated occupant. The pair of left and right thigh belts are configured to be withdrawable from the third retractor mechanism to restrain thighs of the seated occupant. The retractor mechanism may be disposed inside the seat cushion 10, the seat back 20 or any other part of the vehicle and is not intended to limit the disclosure.

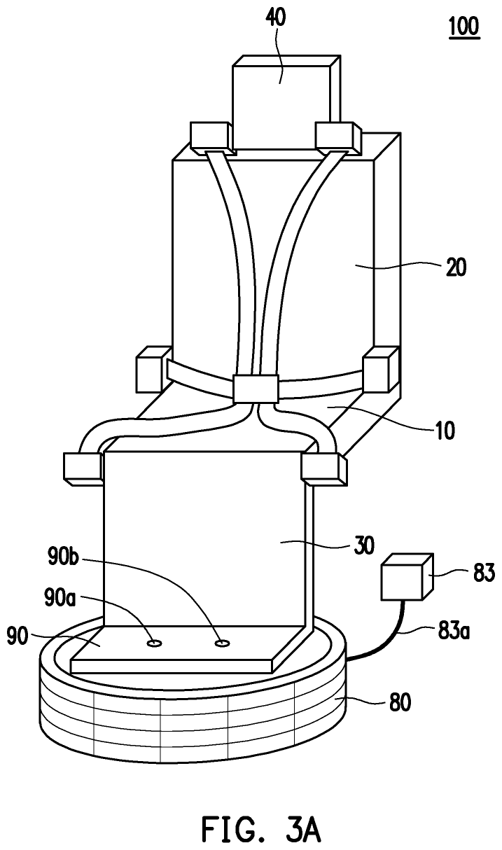

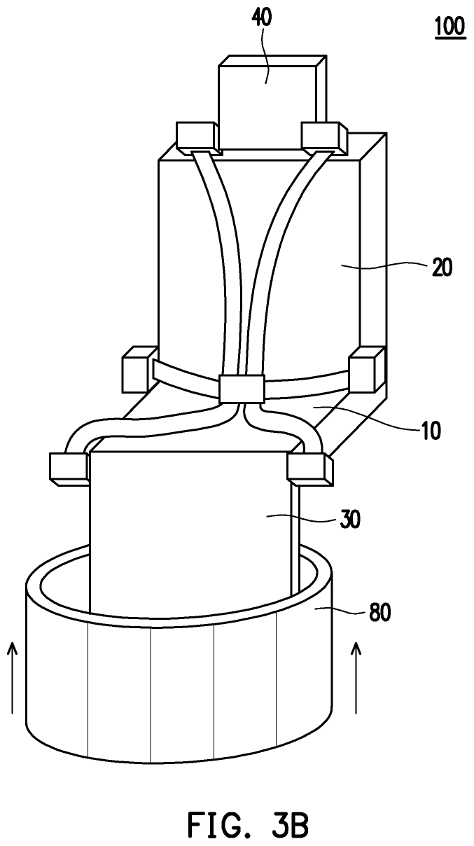

FIG. 3A is a schematic diagram illustrating an undeployed state of an airbag system for lower extremities according to an embodiment of the disclosure. FIG. 3B is a schematic diagram illustrating a deployed state of the airbag system for lower extremities according to an embodiment of the disclosure. Referring to FIGS. 3A and 3B, the occupant protection device 100 includes an inflatable airbag 80 and a gas generator 83. The airbag 80 includes a cushion designed to inflate rapidly and protect passengers from impact in the event of a vehicle collision. A hose 83a connects the gas generator 83 and the airbag 80. The airbag 80 is disposed at the feet rest 90. More specifically, the airbag 80 is disposed on a floor of the vehicle at the foot rest 90 and configured to deploy in an event of a collision of the vehicle. The airbag 80 deploys from the floor (or from the feet rest 90) in a direction towards the seat cushion 10 to cover the ottoman 30 in the event of the collision of the vehicle. That is to say, in the event of the vehicle collision, the airbag 80 is inflated with gas from the gas generator 83 via the hose 83a. The gas may be, for example, air. The type of gas is not intended to limit the disclosure. The gas generator 83 may be disposed, for example, on the ottoman 83 or on the floor and the like.

In the present embodiment, the airbag 80 has a tubular structure. The tubular structure of the airbag 80 surrounds the foot rest 90. In other words, the foot rest 90 is disposed in the center of the tubular structure of the airbag 80. When the airbag 80 is inflated, the airbag 80 is pulled up to form a cylindrical structure around the ottoman 30 and around the foot rest 90 to surround the lower limbs of the seated occupant. In the undeployed state, the structure of the airbag 80 may be, for example, folded or rolled and stored in the bottom section of the seat, for example, inside or under the foot rest 90. A deployment of the airbag 80 is triggered by a pre-crash or crash sensor. The gas generator 83 inflates, for example, longitudinal tubular channels in the structure of the airbag 80, unfolding the structure upwards around the lower extremities of the seated occupant. During the vehicle collision, the deployed airbag 80 limits the movements of the lower extremities of the seated occupant by surrounding the ottoman 30 and surrounding the foot rest 90, to cushion the impact of the moving lower extremities, and protects lower extremities against intrusive parts. A material of the airbag 80 may be, for example, fabric, foil, net and/or the like. A shape of the airbag 80 is not limited hereto and may have other shapes such as a square or a polygon and the like according to requirements.

The airbag 80 may surround the entirety of the ottoman 30 and the entirety of the foot rest 90. In other words, the airbag 80 may surround 360 degrees of the ottoman 30 and surround 360 degrees of the foot rest 90. However, the disclosure is not limited thereto. The airbag 80 may surround a portion of the ottoman 30 and a portion of the foot rest 90. For example, the airbag 80 may surround one side of the ottoman 30 on which the foot rest 90 is disposed. The other side of the ottoman 30 in which the foot rest 90 is not disposed may not be surrounded by the airbag 80. That is to say, one side of the foot rest 90 may be surrounded by the ottoman 30 while another side of the foot rest 90 opposite the ottoman 30 may be surrounded by the airbag 80.

In an embodiment of the disclosure, the occupant protection device 100 may include a first sensor 90a and a second sensor 90b disposed on the foot rest 90. The sensors 90a, 90b may be, for example, infrared sensors that detect a presence of the feet of the occupant. A type of the sensor is not intended to limit the disclosure. In more detail, the sensors 90a, 90b are configured to detect whether the feet of the seated occupant is placed on the foot rest 90. For example, the sensor 90a may detect the presence of the right foot of the occupant. Furthermore, the sensor 90b may detect the presence of the left foot of the occupant. In the event of the vehicle collision, the airbag 80 may be configured to deploy when both of the sensors 90a, 90b detect that the feet of the seated occupant is placed on the foot rest 90. Otherwise, the deployment of the airbag 80 may be suppressed. A number of the sensors is not intended to limit the disclosure. In another embodiment of the disclosure, the airbag 80 may be configured to deploy when one sensor detects that the feet of the seated occupant is placed on the foot rest 90.

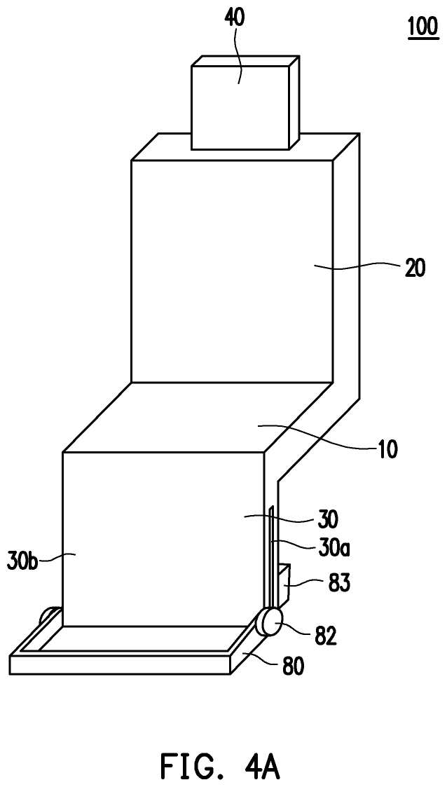

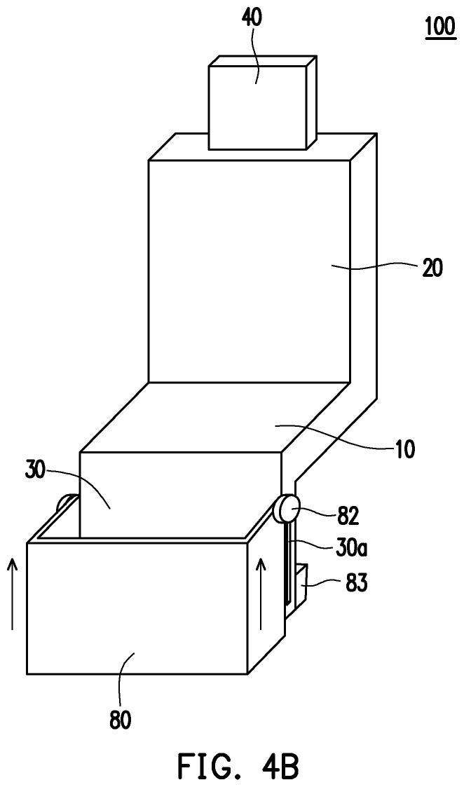

FIG. 4A is a schematic diagram illustrating an undeployed state of an airbag system having a guide rail according to an embodiment of the disclosure. FIG. 4B is a schematic diagram illustrating a deployed state of the airbag system having a guide rail according to an embodiment of the disclosure. Referring to FIGS. 4A and 4B, in an embodiment of the disclosure, the occupant protection device 100 may include a first guide rail 30a and a second guide rail 30b disposed on side surfaces of the ottoman 30. More specifically, the first guide rail 30a is disposed at a first side surface of the ottoman 30 and the second guide rail 30b is disposed at a second side surface of the ottoman 30. The first side surface of the ottoman 30 is a surface opposite to the second side surface of the ottoman 30. A number of the guide rails is not intended to limit the disclosure. The airbag 80 may include, for example, a first linear block 82 and a second linear block (not shown) coupled or fixed to the airbag 80, wherein the first linear block 82 slides on the first guide rail 30a, and the second linear block slides on the second guide rail 30b, such that the first guide rail 30a and the second guide rail 30b are configured to guide the air bag 80 to deploy from the floor of the vehicle (or from the feet rest 90) towards the seat cushion 10.

By deploying the airbag 80 from the floor to cover the ottoman 30, the airbag 80 may be reliably aimed to deploy at the lower extremities of the seated occupant, and the movement of the lower limbs of the seated occupant may be restrained. Furthermore, by utilizing the sensor for detecting the placement of the feet of the seated occupant, the airbag 80 may be suppressed from deploying when the feet of the seated occupant is not placed on the foot rest 90. Furthermore, the airbag 80 may be more accurately deployed when the sensor detects the feet of the seated occupant is placed on the foot rest 90. In addition, by disposing the guide rails on the ottoman 30, the airbag 80 may be more stably deployed upward. Furthermore, since the airbag is firmly connected to the floor and the ottoman 30 via the guide rails, the legs of the seated occupant may be prevented from spilling out of the airbag 80 even when the legs of the seated occupant come in contact with the airbag 80 during the vehicle collision. In this way, the lower extremities of the seated occupant are restrained.

In an embodiment of the disclosure, in order to reduce cost, a tubular structure without an air cushion (without the airbag) may be pulled up around the lower limbs of the seated occupant to limit the movements of the lower extremities of the seated occupant, instead of the airbag 80. A propulsion system (electric motor, pyrotechnical device, gas generator or similar) may move pulling elements upwards along the sides (e.g., small gliding blocks in guiding rails) of the ottoman 30. These pulling elements are connected via strips with the upper ends of the stored structure. If the propulsion actuator moves the pulling elements upwards, the structure may be pulled up around the lower extremities of the seated occupant.

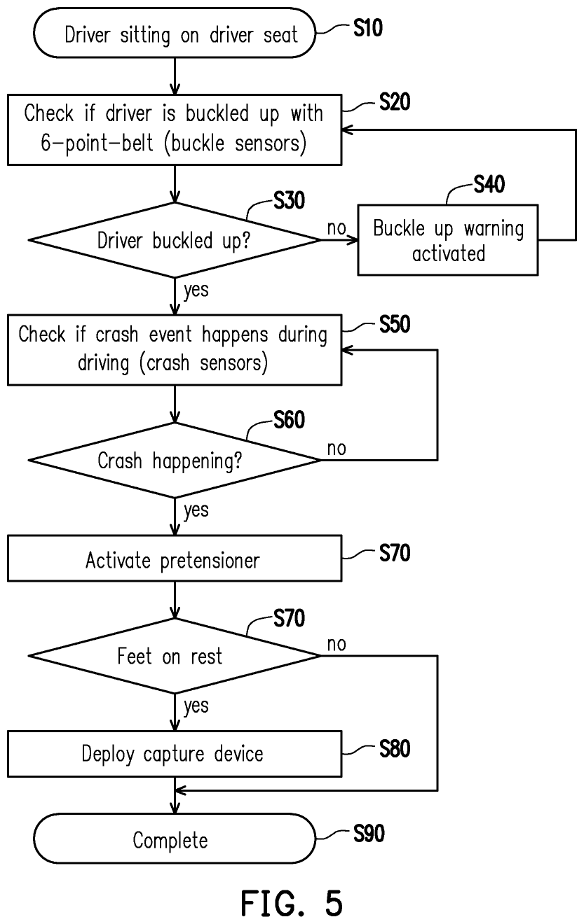

FIG. 5 is a schematic flow diagram illustrating a deployment of a safety restraint system for lower extremities according to an embodiment of the disclosure. First, a computer checks if the driver is sitting on the driver seat. Next, the computer checks if the driver is buckled up with 6-point-belt (through buckle sensors). When the driver is not buckled up, a buckle up warning is activated. If the driver is buckled up, the computer checks if a crash is happening. If the computer detects a crash is happening, the pretensioner is activated to remove slack from the 6-point belt system. Next, the computer detects whether the feet of the driver are placed on the foot rest 90 (through sensors). If the feet of the driver are detected, the capture device (the airbag 80 or a tubular structure) is deployed to be pulled up around the lower extremities of the seated occupant. It should be noted, the flow diagram shown of FIG. 5 is applicable to a driver seat and/or a passenger seat.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An occupant protection device adapted for a vehicle, the occupant protection device comprising:
a pair of first and second lap belt guiding surfaces disposed towards a rear side of a seat cushion in a front-rear direction of the seat cushion, the first lap belt guiding surface is disposed at a first side surface of the seat cushion and the second lap belt guiding surface is disposed at a second side surface of the seat cushion;
a pair of left and right lap belts, configured to be withdrawable from the pair of first and second lap belt guiding surfaces to restrain a waist of a seated occupant;
a pair of first and second shoulder belt guiding surfaces disposed at a side of a seat back that is away from the seat cushion;
a pair of left and right shoulder belts, configured to be withdrawable from the pair of first and second shoulder belt guiding surfaces to restrain an upper body of the seated occupant;
a pair of first and second thigh belt guiding surfaces disposed towards a front side of the seat cushion in the front-rear direction of the seat cushion, the first thigh belt guiding surface is disposed at a third side surface of the seat cushion and the second thigh belt guiding surface is disposed at a fourth side surface of the seat cushion;
a pair of left and right thigh belts, configured to be withdrawable from the pair of first and second thigh belt guiding surfaces to restrain thighs of the seated occupant; and
a connector, wherein the lap belts, the shoulder belts and the thigh belts are connected to the connector.

2. The occupant protection device according to claim 1, further comprising:
an ottoman, provided at the seat cushion and configured to support legs of the seated occupant;
an airbag, disposed on a floor or a foot rest of the vehicle and configured to deploy in an event of a collision of the vehicle, the airbag deploys from the floor or from the foot rest in a direction towards the seat cushion to cover the ottoman in the event of the collision of the vehicle.

3. The occupant protection device according to claim 2, further comprising:
a sensor, configured to detect whether a foot of the seated occupant is placed on the foot rest;
wherein the foot rest is provided at the ottoman and configured to function as a feet rest of the seated occupant,
wherein, in the event of the collision of the vehicle, the airbag deploys when the sensor detects that the foot of the seated occupant is placed on the foot rest.

4. The occupant protection device according to claim 2, further comprising:
a first guide rail disposed at a first side surface of the ottoman;
a second guide rail disposed at a second side surface of the ottoman;
wherein the first guide rail and the second guide rail are configured to guide the air bag to deploy from the floor of the vehicle towards the seat cushion.

5. An occupant protection device adapted for a vehicle, the occupant protection device comprising:
a pair of first and second lap belt guiding surfaces disposed towards a rear side of a seat cushion in a front-rear direction of the seat cushion, the first lap belt guiding surface is disposed at a first side surface of the seat cushion and the second lap belt guiding surface is disposed at a second side surface of the seat cushion;
a pair of left and right lap belts, configured to be withdrawable from the pair of first and second lap belt guiding surfaces to restrain a waist of a seated occupant;
a pair of first and second shoulder belt guiding surfaces disposed at a side of a seat back that is away from the seat cushion;
a pair of left and right shoulder belts, configured to be withdrawable from the pair of first and second shoulder belt guiding surfaces to restrain an upper body of the seated occupant;
a pair of first and second thigh belt guiding surfaces disposed towards a front side of the seat cushion in the front-rear direction of the seat cushion, the first thigh belt guiding surface is disposed at a third side surface of the seat cushion and the second thigh belt guiding surface is disposed at a fourth side surface of the seat cushion;
a pair of left and right thigh belts, configured to be withdrawable from the pair of first and second thigh belt guiding surfaces to restrain thighs of the seated occupant;
a connector, wherein the lap belts, the shoulder belts and the thigh belts are connected to the connector,
an ottoman, provided at the seat cushion and configured to support legs of the seated occupant; and
an airbag, disposed on a floor of the vehicle and configured to deploy in an event of a collision of the vehicle, the airbag deploys from the floor in a direction towards the seat cushion to cover the ottoman in the event of the collision of the vehicle.
